(19) United States
(12) Patent Application Publication
(10) Pub. No.: US 2005/0209374 A1
(43) Pub. Date: Sep. 22, 2005

(54) Anaerobically biodegradable polyesters

(76) Inventors: Andrew Joseph Matosky, Kingsport, TN (US); Leia Georganna Vanzant, Gray, TN (US); Ted Calvin Germroth, Kingsport, TN (US); Candace Michele Tanner, Kingsport, TN (US)

Correspondence Address: B. J. Boshears;Eastman Chemical Company, P.O. Box 511, Kingsport, TN, 37662-5075, US

(21) Appl. No.: 10/852,502

(22) Filed: May 24, 2004

Related U.S. Application Data
(60) Provisional application No. 60/554,838, filed on Mar. 19, 2004.

(51) Int. Cl. C08L 3/00

(52) U.S. Cl. 524/47

(57) ABSTRACT

Anaerobically biodegradable polyesters, and compositions and articles of manufacture containing the polyesters are described. Polyesters previously thought to be non-biodegradable under anaerobic conditions have been surprisingly and unexpectedly rendered anaerobically biodegradable by controlling the aromatic monomer content in the polyester. These polyesters can be made into fibers, films, non-woven fabrics, and adhesives. They are suitable for use in absorbent articles such as flushable personal hygiene products.

### RELATED APPLICATIONS

This application claims priority to U.S. Provisional Application 60/554,838 filed on Mar. 19, 2004.

### FIELD OF THE INVENTION

This invention generally relates to anaerobically biodegradable polyesters. The invention also relates to compositions and articles of manufacture containing or made from the polyesters. Particularly useful articles include films, fibers, non-woven fabrics, and adhesives. These articles can be used to make other anaerobically biodegradable end-use articles such as diapers, feminine-hygiene products, and incontinence briefs.

### BACKGROUND OF THE INVENTION

Films, fibers, melt-blown webs, and other melt-spun fibrous articles have been made from thermoplastic polymers, such as polypropylene and polyesters. These films, fibers, and fibrous articles are commonly used in non-woven fabrics and composite structures containing continuous films and, in particular, personal care products such as wipes, feminine and personal hygiene products, baby diapers, adult incontinence briefs, hospital/surgical and other medical disposables, protective fabrics and layers, geotextiles, and filter media.

Unfortunately, the personal care products made from conventional thermoplastic polymers are difficult to dispose of and are usually placed in landfills or composting facilities. One promising alternative method of disposal is to make these products or their components “flushable”, i.e., compatible with wastewater disposal systems such as sewers, septic tanks, and the like. Another incentive to producing a truly flushable article is that many of the above items, through their normal use, become contaminated with human fluids, such as blood or waste, that can carry infectious diseases. Therefore, flushing these contaminated articles provides an effective, low-cost way to dispose of the articles in a manner that limits the opportunity for inadvertent exposure.

Flushability has traditionally been focused on compatibility with domestic and municipal plumbing fixtures, and has been defined as the ability to reduce the bulk of the product to be disposed by the consumer in an aqueous environment (e.g., dispersible upon contact with water in a toilet or industrial hot-water treatment). There have been numerous inventions relating to achieving this degree of compatibility. Various approaches to addressing these needs have been described, for example, in U.S. Pat. Nos. 6,548,592; 6,552,162; 5,281,306; 5,292,581; 5,935,880; and 5,509,913, U.S. patent application Ser. Nos. 09/775,312 and 09/752,017, and PCT International Publication No. WO 01/66666 A2. Essentially, this type of compatibility relies on physical disintegration to ensure passage into wastewater disposal systems, but does not address what happens to these components/materials in the systems that normally rely on microorganism digestion to operate acceptably.

With the increased volumes of consumer products introduced as flushable articles, the compatibility focus has transferred to the effect of the product on the wastewater collection and treatment systems once it is dispersed. Most systems represent low oxygen environments, ranging from partially anaerobic to fully anaerobic. The ability of an article to degrade under these conditions is highly desirable.

One attempt to provide an article having the ability to degrade under anaerobic conditions is described in U.S. Patent Application Publication No. U.S. 2002/0042599. The publication reports that polyesteramides, polyhydroxyalkoates, and mixtures thereof are anaerobically degradable. In Comparative Examples 4a and 4b, the publication notes that aliphatic polyester Bionolle 3001 and aliphatic-aromatic copolyester Eastar 14766 “do not provide satisfactory degradability in an anaerobic sludge.”

Thus, there continues to be a need for polymers, particularly aliphatic-aromatic copolyesters, and articles made therefrom that can biodegrade under partially or completely anaerobic conditions.

### SUMMARY OF THE INVENTION

In one aspect, the invention relates to aliphatic-aromatic polyesters that comprise aromatic monomers in an amount effective to render them anaerobically biodegradable. In one embodiment, the anaerobically biodegradable polyesters comprise: (a) diacid residues comprising from about 39 to about 43 mole percent of residues from an aromatic dicarboxylic acid and from about 57 to about 61 mole percent of residues from a non-aromatic dicarboxylic acid; and (b) diol residues comprising from about 85 to about 100 mole percent of residues from 1,4-butanediol and from about 0 to about 15 mole percent of residues from another diol. In another embodiment, the polyesters comprise: (a) diacid residues comprising from about 39 to about 43 mole percent of residues from terephthalic acid and from about 57 to about 61 mole percent of residues from adipic acid or glutaric acid; and (b) diol residues comprising about 100 mole percent of residues from 1,4-butanediol.

In another aspect, the invention relates to compositions comprising the anaerobically biodegradable polyesters and a thermoplastic starch, inorganic salt, or both.

In yet another aspect, the invention relates to articles of manufacture made from or containing the anaerobically biodegradable polyesters and compositions of the invention. Such articles include films, fibers, non-woven fabrics, and adhesives.

The polyesters and compositions are particularly useful in absorbent articles and tampon applicator assemblies.

### BRIEF DESCRIPTION OF THE DRAWINGS

FIG. 1 is a bar chart showing the efficiency of ¹⁴CO₂ collection by the two Carbosorb E traps used in Example 2.

FIG. 2 is a graph showing the cumulative percentage of biodegradation of three polyester films containing approximately 42, 43, and 46 mol % terephthalate over a 180-day period.

### DETAILED DESCRIPTION OF THE INVENTION

Aliphatic-aromatic polyesters are known to be biodegradable under aerobic conditions. But when these materials are exposed to the anaerobic conditions typical of the septic or sewage system, they generally fail to degrade significantly within a reasonable amount of time. See, e.g., U.S. 2002/0042599 A1 at paras. 0003 and 0091. We have surprisingly and unexpectedly discovered, however, that aliphatic-aromatic polyesters can be made anaerobically biodegradable by limiting the amount of aromatic monomers in the polyester.

As used herein, the indefinite article “a” means one or more.

Unless otherwise indicated, all numbers expressing quantities of ingredients, properties such as molecular weight, reaction conditions, and so forth used in the description and claims are to be understood as being modified in all instances by the term “about.” Accordingly, unless indicated to the contrary, the numerical parameters set forth in the following description and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters describing the invention are approximations, the numerical values set forth in the specific examples are reported as precisely as possible. Any numerical value, however, inherently contains certain errors necessarily resulting from the standard deviation found in their respective testing measurements.

The term “polyester”, as used herein, is intended to include “copolyesters”. In general, polyesters are synthetic polymers prepared by the polycondensation of one or more difunctional carboxylic acids with one or more difunctional hydroxyl compounds. Typically, the difunctional carboxylic acid is a dicarboxylic acid, and the difunctional hydroxyl compound is a dihydric alcohol such as, for example, glycols and diols. The polyester may optionally be modified with one or more hydroxycarboxylic acids (or their polyester-forming derivatives). Alternatively, polyesters can be formed via a ring opening reaction of cyclic lactones; for example, as in polylactic acid prepared from its cyclic lactide or polycaprolactone formed from caprolactone.

The term “aliphatic-aromatic polyester”, as used herein, means a polyester comprising a mixture of residues from aliphatic or cycloaliphatic dicarboxylic acids or diols and aromatic dicarboxylic acids or diols.

The term “aromatic” means the dicarboxylic acid or diol contains an aromatic nucleus in the backbone such as, for example, terephthalic acid or 2,6-naphthalene dicarboxylic acid.

The term “non-aromatic”, as used herein with respect to the dicarboxylic acid, diol, and hydroxycarboxylic acid monomers, means that carboxyl or hydroxyl groups of the monomer are not connected through an aromatic nucleus. For example, adipic acid contains no aromatic nucleus in its backbone, i.e., the chain of carbon atoms connecting the carboxylic acid groups; thus, it is “non-aromatic”. “Non-aromatic” is intended to include both aliphatic and cycloaliphatic structures such as, for example, diols, diacids, and hydroxycarboxylic acids, that contain as a backbone a straight or branched chain or cyclic arrangement of the constituent carbon atoms which may be saturated or paraffinic in nature, unsaturated (i.e., containing non-aromatic carbon-carbon double bonds), or acetylenic (i.e., containing carbon-carbon triple bonds). Thus, in the context of the description and the claims of the present invention, “non-aromatic” is intended to include linear and branched, chain structures (referred to herein as “aliphatic”) and cyclic structures (referred to herein as “alicyclic” or “cycloaliphatic”). The term “non-aromatic”, however, is not intended to exclude any aromatic substituents that may be attached to the backbone of an aliphatic or cycloaliphatic diol or diacid or hydroxycarboxylic acid. In the present invention, the difunctional carboxylic acid may be an aliphatic or cycloaliphatic dicarboxylic acid such as, for example, adipic acid, or an aromatic dicarboxylic acid such as, for example, terephthalic acid. The difunctional hydroxyl compound may be cycloaliphatic diol such as, for example, 1,4-cyclohexanedimethanol, a linear or branched aliphatic diol such as, for example, 1,4-butanediol, or an aromatic diol such as, for example, hydroquinone.

The term “residue”, as used herein, means any organic structure incorporated into a polymer through a polycondensation reaction involving the corresponding monomer.

The term “repeating unit”, as used herein, means an organic structure having a dicarboxylic acid residue and a diol residue or hydroxycarboxylic acid residues bonded through a carbonyloxy group. Thus, the dicarboxylic acid residues may be derived from a dicarboxylic acid monomer or its associated acid halides, esters, salts, anhydrides, or mixtures thereof.

As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The term “hydroxycarboxylic acid”, as used in the context of optionally modifying the polyesters of the present invention, refers to monohydroxy-monocarboxylic acids including aliphatic and cycloaliphatic hydroxycarboxylic acids and any derivative thereof, including their associated acid halides, esters, cyclic esters (including dimers such as lactic acid lactides), salts, anhydrides, mixed anhydrides, or mixtures thereof, useful in a polycondensation process or ring opening reaction to make a high molecular weight polyester.

The term “anaerobically biodegradable” means the polyester, composition, or article (such as films, fibers, nonwovens, laminates, shaped articles, etc.) is capable of being at least partially degraded, weakened, broken into pieces, disintegrated, or dissolved, in an anaerobic or microaerophilic environment such as those encountered in an active sewage sludge obtained from a municipal waste water treatment plant or septic system within a reasonable amount of time, such as from 1 to 3 months.

Whether materials undergo complete biodegradation has been debated in International Standards organizations, such as the ASTM, US Composting Council, CEN (Europe), DIN (Germany), and Asia. Throughout the world, however, it is agreed that fragmentation and disintegration, although early steps in the total process, are insufficient evidence of total biodegradation. Complete biodegradation, whether under aerobic or anaerobic (or in between) conditions, results in the carbon of the material biodegrading into microbial cell mass and eventually evolving as carbon dioxide. Further, although reduction in tensile strength, elongation, molecular weight, oxygen uptake, or mass may suggest biodegradation, only the final evolution of carbon dioxide is universally accepted as an indicator of complete biodegradation in both aerobic and anaerobic biodegradation. This complete evolution of the carbon into CO₂, microbial cell mass, and inorganic chemicals is often defined as mineralization.

Microorganisms exhibit a wide range of tolerance to and differential requirements for oxygen. Even organisms considered strict anaerobes can metabolize oxygen when it is available, though they do not grow well in the presence of this gas. In biodegradable communities of microorganisms, a whole range of oxygen requirements are observed.

Strictly speaking, the term “anaerobic” means without air (or more specifically, free oxygen), but almost no liquid biodegradation medium is completely without air. Thus, a better description of a septic tank or sewage environment would be microaerophilic (very small amount of air). Just the addition of new material with liquid into a septic tank or sewage system (by flushes) necessarily carries with it some dissolved oxygen. Therefore, the term “anaerobic” is not used herein in its literal sense. It is used more broadly to mean partially or completely depleted of free oxygen, such as the microaerophilic environment typically encountered in a septic tank or sewage system.

It is well documented that some compounds are metabolized only when oxygen is not present and that the available oxygen is depleted by aerobic and microaerophilic organisms. Examples are phenolic compounds and highly chlorinated molecules. The components of aliphatic-aromatic polyesters, such as EASTAR BIO copolyester, are not among these compounds. In a completely anaerobic environment, it has been observed that no biodegradation or even fragmentation of EASTAR BIO copolyester occurs. Indeed, a film of EASTAR BIO copolyester placed in grass clippings (which has been demonstrated to be an extremely aggressive microbial environment for EASTAR BIO under aerobic conditions) did not even begin to fragment after five years in a completely anaerobic environment.

It was also observed in earlier testing that films containing percentages of terephthalic acid exceeding 48 mole % biodegraded much more slowly in an aerobic environment and did not even begin to fragment in a microaerophilic (partially anaerobic) environment in 6 months. The rate of EASTAR BIO copolyester biodegradation in an aerobic environment is very significantly affected by the percentage of terephthalic acid. Films of the same thickness but of low percentages (e.g., 41-43 mole %) of terephthalic acid biodegrade in an aerobic environment exponentially faster than films containing 46-48 mole %, and by several orders of magnitude faster than films containing greater than 50 mole % terephthalic acid. It is also documented that the initiation of anaerobic biodegradation have ‘extremely long periods of acclimatization.” Earlier studies and, in particular, the lack of fragmentation of the 48% terephthalic acid film under completely anaerobic conditions led most researchers to believe that aliphatic-aromatic polyesters would not be a candidate for septic/sewage environments.

The studies cited here, however, demonstrate that at very low percentages of terephthalic acid (e.g., below 43 mole %), aliphatic-aromatic polyesters can indeed fragment and mineralize under septic/sewage conditions.

The anaerobically biodegradable polyesters of the present invention typically are prepared from dicarboxylic acids and diols, which react in substantially equal proportions, and are incorporated into the polyester polymer as their corresponding residues. They may optionally be prepared in the additional presence of hydroxycarboxylic acids or polyester-forming derivatives thereof. The polyesters derived from dicarboxylic acid and diol residues of the present invention, therefore, contain substantially equal molar proportions of diacid residues (100 mole %) and diol residues (100 mole %) such that the total moles of repeating units is equal to 100 mole %. The polyesters can be modified by incorporating hydroxycarboxylic acids without affecting these 100 mole % totals (i.e., hydroxycarboxylic acids do not enter into this 100 mole % counting since they already contain a stoichiometric balance between acid and hydroxy groups).

The mole percentages of diacids in the present disclosure are expressed as a fraction (or percentage) of the total moles of diacid residues in any particular polymer sample. For example, a copolyester containing 60 mole % adipic acid, based on the total diacid residues, means that the copolyester contains 60 mole % adipic acid residues out of a total of 100 mole % diacid residues. Thus, there are 60 moles of adipic acid residues among every 100 moles of diacid residues.

Similarly, the mole percentages of diols are expressed as a fraction (or percentage) of the total moles of diol residues in the polymer sample. For example, a copolyester containing 15 mole % ethylene glycol, based on the total diol residues, means that the copolyester contains 15 mole % of ethylene glycol residues out of a total of 100 mole % of diol residues. Thus, there are 15 moles of ethylene glycol residues among every 100 moles of diol residues.

The mole percentages of hydroxycarboxylic acids herein are expressed as a fraction (or percentage) of the total moles of diacid residues in the polymer sample. For example, a polymer comprising of 10 mole % of a hydroxycarboxylic acid, 60 mole % of adipic acid, 40 mole % of terephthalic acid, and 100 mole % of butandiol means that there is one tenth the number of moles of hydroxycarboxylic acid residues in the sample as there are moles of diacid residues (in this case, moles of adipic acid residues plus moles of terephthalic acid residues) in the sample. Therefore, in the case of copolymers containing hydoxycarboxylic acids, the total mole % of all components add up to greater than 200 (x mole % hydroxycarboxylic acids+100 mole % diacids+100 mole % diols).

The anaerobically biodegradable polyesters of the invention may comprise residues of one or more non-aromatic dicarboxylic acids. Examples of non-aromatic dicarboxylic acids include glutaric and adipic.

In addition to the non-aromatic dicarboxylic acids, the anaerobically biodegradable polyesters may comprise residues of aromatic dicarboxylic acids. Examples of aromatic dicarboxylic acids that may be used include terephthalic acid, isophthalic acid, 5-sulfoisophthalic acid, and 2,6-naphthalenedicarboxylic acid. In one embodiment, the aromatic dicarboxylic acid comprises terephthalic acid with up to 5 mole % of the terephthalic acid being replaced with one or more of isophthalic acid, 5-sulfoisophthalic acid, and 2,6-naphthalenedicarboxylic acid.

The aromatic dicarboxylic acid residues are present in the polyesters of the invention in an amount that is effective to render the polyesters biodegradable under anaerobic conditions. The precise amount will depend on the particular combination of aromatic and non-aromatic dicarboxylic acids as well as diols and hydroxycarboxylic acids used to prepare the polyesters. Generally, aliphatic-aromatic polyesters containing from about 39 to about 43 mole % of aromatic dicarboxylic acid residues, based on the total moles of diacid residues in the polyester, can be expected to be anaerobically biodegradable. Aliphatic-aromatic polyesters containing from about 40 to about 42 mole % of aromatic dicarboxylic acid residues, based on the total moles of diacid residues in the polyester, can also be expected to be anaerobically biodegradable. When compounded with generally easily biodegradable material such as thermoplastic starch, additional aromatic dicarboxylic acid residue ranges that can be expected to yield anaerobically biodegradable polyester compositions include from about 39 to about 46 mole %, and from about 41 to about 43 mole %.

Examples of diols that may be used in the polyesters of the present invention include, but are not limited to, ethylene glycol, diethylene glycol, propylene glycol, 1,3-propanediol, 2,2-dimethyl-1,3-propanediol, 1,3-butanediol, 1,4-butanediol, 1,5-pentanediol, 1,6-hexanediol, polyethylene glycol, diethylene glycol, 2,2,4-trimethyl-1,6-hexanediol, thiodiethanol, 1,3-cyclohexanedimethanol, 1,4-cyclo-hexanedimethanol, 2,2,4,4-tetramethyl-1,3-cyclobutanediol, triethylene glycol, and tetraethylene glycol with the preferred diols comprising one or more diols selected from ethylene glycol, diethylene glycol, 1,3-propanediol, 1,4-butanediol, 1,5-pentanediol, 1,6-hexanediol, and 1,4-cyclohexanedimethanol. In one embodiment, the polyesters of the invention comprise from about 85 to about 100 mole % of residues from 1,4-butanediol and from about 0 to about 15 mole percent of residues from another diol. In another embodiment, the polyesters comprise about 100 mole % of 1,4-butanediol residues.

The anaerobically biodegradable polyesters of the instant invention can be readily prepared from the appropriate dicarboxylic acids, esters, anhydrides, or salts, the appropriate diol or diol mixtures, and any branching agents using typical poly-condensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors.

The anaerobically biodegradable polyesters of the present invention can be prepared by procedures known to persons skilled in the art and described, for example, in U.S. Pat. No. 2,012,267. Such reactions are usually carried out at temperatures from 150° C. to 300° C. in the presence of polycondensation catalysts such as, for example, alkoxy titanium compounds, alkali metal hydroxides and alcoholates, salts of organic carboxylic acids, alkyl tin compounds, metal oxides, and the like. The catalysts are typically employed in amounts between 10 to 1000 ppm, based on total weight of the reactants.

The polyesters can be modified by incorporating up to about 15 mole % of hydroxycarboxylic acid residues, based on the total moles of diacid residues. The total mole % of (1) aliphatic diacid residues; (2) diol residues other than 1,4-butanediol residues, if any; and (3)hydroxycarboxylic acid residues, if any, is desirably less than about 65. In other embodiments, the total mole % of (1)+(2)+(3) can range from about 50 to about 65, about 55 to about 62, or about 58 to about 62. Examples of suitable hydroxycarboxylic acids include gamma-butyrolactone; caprolactone; lactic acid (D or L-form or mixtures thereof); aliphatic hydroxyalkylates including 4-hydroxybutanoic acid, 4-hydroxyvaleric acid, 4-hydroxyhexanoic acid, and 4-hydroxyoctanoic acid; and derivatives thereof useful for the production of polyesters. These hydroxycarboxylic acids can be incorporated by direction reaction into the polyester through conventional means by reacting them in their free acid form or other polyester forming derivatives, for example their esters (including cyclic esters called lactones), or by reactive blending them with the above polyesters in their polymeric form such as polyhydroxyalkanoates (PHAs) such as polyhydroxybutyrate (PHB), polyhydroxybutyrate-co-valerate (PHBv), polyhydroxybutyrate-co-octanoate (PHBO), and polyhydroxybutyrate-co-hexanoate (PHBHx); polycaprolactone (PCL), and polylactic acid (PLA) from synthetic or natural sources.

The anaerobically biodegradable polyesters can comprise from about 10 to about 1,000 repeating units. They can also comprise from about 15 to about 600 repeating units. The anaerobically biodegradable polyesters can have an inherent viscosity of about 0.4 to about 2.0 dL/g, or about 0.7 to about 1.4, as measured at a temperature of 25° C. using a concentration of 0.5 gram polyester in 100 ml of a 60/40 by weight solution of phenol/tetrachloroethane.

The anaerobically biodegradable polyesters, optionally, may contain the residues of a branching agent. The weight percentage ranges for the branching agent are from about 0 to about 2 wt %, about 0.1 to about 1 wt %, or about 0.1 to about 0.5 wt %, based on the total weight of the polyester. The branching agent can have a weight average molecular weight of about 50 to about 5000 or about 92 to about 3000, and a functionality of about 3 to about 6. For example, the branching agent may be the esterified residue of a polyol having 3 to 6 hydroxyl groups, a polycarboxylic acid having 3 or 4 carboxyl groups (or ester-forming equivalent groups), or a hydroxy acid having a total of 3 to 6 hydroxyl and carboxyl groups.

Representative low molecular weight polyols that may be employed as branching agents include glycerol, trimethylolpropane, trimethylolethane, polyethertriols, glycerol, 1,2,4-butanetriol, pentaerythritol, 1,2,6-hexanetriol, sorbitol, 1,1,4,4,-tetrakis (hydroxymethyl)cyclohexane, tris(2-hydroxyethyl)isocyanurate, and dipentaerythritol. Particular branching agent examples of higher molecular weight polyols (MW 400-3000) are triols derived by condensing alkylene oxides having 2 to 3 carbons, such as ethylene oxide and porpylene oxide with polyol initiators.

Representative polycarboxylic acids that may be used as branching agents include hemimellitic acid, trimellitic (1,2,4-benzenetricarboxylic) acid and anhydride, trimesic (1,3,5-benzenetricarboxylic) acid, pyromellitic acid and anhydride, benzenetetracarboxylic acid, benzophenone tetracarboxylic acid, 1,1,2,2-ethane-tetracarboxylic acid, 1,1,2-ethanetricarboxylic acid, 1,3,5-pentanetricarboxylic acid, and 1,2,3,4-cyclopentanetetracarboxylic acid. Although the acids may be used as such, they can also be used in the form of their lower alkyl esters or their cyclic anhydrides in those instances where cyclic anhydrides can be formed.

Representative “branching hydroxycarboxylic acids” (these hydroxycarboxylic acids differ from the hydroxycarboxylic acids mentioned elsewhere in this description by not containing an equal number of acid and hydroxy groups, and are excluded from the definition of hydroxycarboxylic acids used elsewhere in this description) that may be used as branching agents include malic acid, citric acid, tartaric acid, 3-hydroxyglutaric acid, mucic acid, trihydroxyglutaric acid, 4-carboxyphthalic anhydride, hydroxyisophthalic acid, and 4-(beta-hydroxyethyl)phthalic acid. Such branching hydroxycarboxylic acids contain a combination of 3 or more hydroxyl and carboxyl groups. Representative branching agents include trimellitic acid, trimesic acid, pentaerythritol, trimethylol propane, and 1,2,4-butanetriol.

The anaerobically biodegradable polyesters of the invention may also comprise one or more ion-containing monomers to increase their melt viscosity. The ion-containing monomer can be selected from salts of sulfoisophthalic acid or a derivative thereof. A typical example of this type of monomer is sodiosulfoisophthalic acid or the dimethyl ester of sodiosulfoisophthalic. The typical concentration range for ion-containing monomers is about 0.3 to about 5.0 mole % or about 0.3 to about 2.0 mole %, based on the total moles of diacid residues.

The anaerobically biodegradable polyesters of the instant invention may also comprise from 0 to about 5 wt %, based on the total weight of the polyester, of one or more chain extenders. Exemplary chain extenders are divinyl ethers such as those disclosed in U.S. Pat. No. 5,817,721 or diisocyanates such as, for example, those disclosed in U.S. Pat. No. 6,303,677. Representative divinyl ethers are 1,4-butanediol divinyl ether, 1,5-hexanediol divinyl ether, and 1,4-cyclohexandimethanol divinyl ether. Representative diisocyanates are toluene 2,4-diisocyanate, toluene 2,6-diisocyanate, 2,4′-diphenylmethane diisocyanate, naphthylene-1,5-diisocyanate, xylylene diisocyanate, hexamethylene diisocyanate, isophorone diisocyanate, and methylenebis(2-isocyanatocyclohexane). The workable weight percent ranges are about 0.3 to about 3.5 wt %, based on the total weight percent of the polyester, and about 0.5 to about 2.5 wt %. It is also possible in principle to employ trifunctional isocyanate compounds which may contain isocyanurate and/or biurea groups with a functionality of not less than three, or to replace the diisocyanate compounds partially by tri- or polyisocyanates.

The polyesters of the present invention may be blended with thermoplastic starch to form an anaerobically biodegradable composition. The amount of thermoplastic starch in the composition may range from about 5 to about 70 weight percent, based on the weight of the composition. It is expected that blending with thermoplastic starch will increase the rate of biodegradation of the polyester.

The blending of starch with synthetic polymers such as polyethylene (PE) and polypropylene (PP) has been the subject of increasing interest over recent years. The motivation is keen since starch is an abundant and inexpensive filler material. Moreover, starch may also impart enhanced biodegradability to the resulting blend. These PE and PP polymers, however, are not fit for use in some applications, such as where complete biodegradation is desired.

Natural starch found in plant products can be isolated as a granular powder. Natural starch can be treated at elevated temperature and pressure with addition of defined amounts of water to form a melt. Such a melt is referred to as gelatinized or destructurized starch. Destructurized starch can be mixed with additives such as plasticizers to obtain a thermoplastic starch or TPS. These forms of starch can be mixed with the polyesters of the present invention using conventional techniques such as those described in U.S. Pat. Nos. 5,095,054 and 5,362,777; the entire contents of which are hereby incorporated by reference.

In addition to or in lieu of the TPS, the polyesters of the invention may also be combined with inorganic salts to form an anaerobically biodegradable composition. The composition may comprise at least about 0.1 weight percent of inorganic salts. Nonlimiting examples of the inorganic salts include metal carbonates, metal oxides, metal phosphates, metal chlorides, metal sulfates, and mixtures thereof. Representative metal cations in these inorganic salts may include calcium, potassium, sodium, magnesium, other Group 1 and 11 metal cations, aluminum, titanium and silicon. Representative inorganic salts include talc, calcium carbonate, magnesium carbonate, potassium carbonate, sodium carbonate, calcium chloride, magnesium chloride, calcium phosphate, titanium oxide, silicone oxide, aluminum oxide, and mixtures thereof. Typically, the inorganic salt content ranges from about 0.1 to about 60 wt %, from about 1 to about 50 wt %, or from about 2 to about 40 wt %. In one embodiment, the anaerobically biodegradable composition comprises from about 1 to about 20 wt % calcium carbonate or talc.

Optionally, it may be desirable to incorporate one or more additives into the anaerobically biodegradable compositions of the present invention. Suitable additives include, but are not limited to, processing aids, fillers, surfactants, plasticizers, compatibilizers, impact modifiers, nucleating agents, anti-oxidants, heat or ultraviolet stabilizers, colorants, anti-static agents, lubricants, blowing agents, dispersants, thickening agents, antimicrobials, and mixtures thereof. Typically, these additives comprise up to about 10 wt %, up to about 20 wt %, or up to about 30 wt %, of the composition of the present invention.

The polyesters and compositions of this invention can be made into useful articles of manufacture using conventional methods. Such articles demonstrate the novel and unexpected ability to disintegrate and subsequently mineralize into carbon dioxide, water, and biomass under partially anaerobic (low oxygen) or completely anaerobic conditions. Thus, this invention includes not only the uniquely useful polyesters and compositions, but also articles of manufacture made from them. Potential articles include, but are not limited to, films, melt-blown webs, spunbond fabrics, bi-component fiber components, adhesive promoting layers, binders for cellulosics, flushable nonwovens and films, dissolvable binder fibers, protective layers, and carriers for active ingredients to be released or dissolved in water. Other extrudable and melt-spun fibrous materials are also possible.

The processing techniques used for producing the final articles include, but are not limited to, melt-blowing, melt-casting, calendering, and spunbonding. Individual component structures may further be combined to achieve the final article structure using conventional means of joining and construction (e.g., solvent or adhesive bonding with suitable solvents or adhesive systems optionally combined with pressure or heat lamination, coextrusion techniques, or combinations of other conventional bonding/joining techniques used in the industry).

The polyesters and compositions of the present invention are particularly suitable for use in disposable absorbent articles. As used herein, the term “absorbent articles” refers to articles that absorb and contain body liquids, and more specifically refers to articles that are placed against or in proximity to the body of the wearer to absorb and contain the various liquids discharged from the body. Additionally, the term “disposable absorbent articles” refers to articles that are intended to be discarded after a single use (i.e., the original absorbent article in its whole is not intended to be laundered or otherwise restored or reused as an absorbent article, although certain materials or all of the absorbent article can be recycled, reused, composted or flushed). The present invention is applicable to various absorbent articles such as diapers, incontinence briefs, incontinence pads, training pants, pull-on diapers, diaper inserts, catamenial pads, sanitary napkins, pantiliners, interlabial devices, tampons, facial tissues, paper towels, breast pads, and the like, as well as other potentially flushable items, such as tampon applicator assemblies (including the barrel and the plunger), tampon cords, wrappers, and packaging for various products, including disposable absorbent articles, disposable gloves, and the like.

These absorbent articles typically comprise a substantially water-impervious backsheet made from a film of the present invention, a substantially water-permeable topsheet joined to, or otherwise associated with the backsheet, and an absorbent core positioned between the backsheet and the topsheet. The topsheet is positioned adjacent to the body-facing surface of the absorbent core. The topsheet can be joined to the absorbent core and to the backsheet by attachment means such as those well known in the art. As used herein, the term “joined” encompasses configurations whereby an element is directly secured to the other element by affixing the element directly to the other element, and configurations whereby the element is indirectly secured to the other element by affixing the element to intermediate member(s) which in turn are affixed to the other element. In some absorbent articles, the topsheet and the backsheet are joined directly to each other at the periphery thereof. The topsheet and backsheet can also be indirectly joined together by directly joining them to the absorbent core by the attachment means.

The invention is further illustrated and described by the following examples.

### EXAMPLES

### Example 1

### Microbial Attachment and Fragmentation Analysis

Films were prepared from a mixture of adipic acid and terephthalic acid as the diacid components and 100 mole % 1,4-butanediol as the diol component using conventional blown film processing equipment in the Technical Service Laboratory of Eastman Chemical Company. The terephthalic acid content and film composition are shown in Table 1.

For the films described in Table 1, the base resin was fed into a 2½″ single screw extruder having a 24:1 length:diameter ratio and using a moderate shear, general purpose polyester screw with no mixing and a 3:1 compression ratio. The resin was dried prior to processing in a desiccant dryer at 150° F. for 8 hours. Process additives were similarly dried prior to processing and delivered to the single screw extrusion process through the use of a gravimetric feeding system. The processing additives and their final concentrations in the films are also shown in Table 1. The additives were incorporated using appropriate amounts of a concentrate of 50 wt % CaCO₃ in the same resin as the base resin or a concentrate of 50 wt % of talc in the same resin as the base resin.

The melt was then delivered through a 6-inch monolayer, spiral mandrel die. A dual-lip air ring using chilled air and no internal bubble cooling was used to produce film with a 2:1 machine direction/cross direction blow up ratio. The film was produced by collapsing the tubular film using a collapsing frame height of 18 feet. The temperature profiles used for processing the films are indicated in Table 3.

Commercial films produced from other aerobically biodegradable polymers were obtained and are described in Table 2.

All films were placed in an operational septic tank (partially anaerobic) environment. After 3 months, the films were retrieved and assessed for degree of microbe attachment and fragmentation.

As used in the tables, T means terephthalic acid and TPS means thermoplastic starch.

TABLE 1
Films Produced At Eastman

| | | Film | | |
|---|---|---|---|---|
| Film | | Thickness | Microbial | |
| ID No. | Film Composition | (mils) | Attachment | Fragmentation |
| 1 | 43 mol % | 1.45 | Excellent | Good |
| | T w/10 wt % talc | | | |
| 2 | 45 mol % | 1.25 | Fair | Very Poor |
| | T w/10 wt % talc | | | |
| 3 | 48 mol % | 1.20 | None | None |
| | T w/15 wt % | | | |
| | CaCO₃ | | | |

TABLE 2
Commercial Films

| | | Film | | |
|---|---|---|---|---|
| Film | | Thickness | Microbial | |
| ID No. | Film Composition | (mils) | Attachment | Fragmentation |
| 4 | Ecoflex BAG | 1.45 | Very Poor | None |
| | (−47 mol % T) w/ | | | |
| | 30 wt % TPS | | | |
| 5 | Belgian | 1.45 | None | None |
| | Competitor | | | |
| | (−47 mol % | | | |
| | T) w/30 wt % TPS | | | |

TABLE 3
Blown Film Processing Conditions

| | | |
|---|---|---|
| Extruder Zone 1 | 150° | C. (300° F.) |
| Extruder Zone 2 | 150° | C. (300° F.) |
| Extruder Zone 3 | 155° | C. (310° F.) |
| Extruder Zone 4 | 160° | C. (320° F.) |
| Adapter | 135° | C. (280° F.) |
| Die Block | 135° | C. (280° F.) |
| Lower Die | 135° | C. (280° F.) |
| Upper Die | 135° | C. (280° F.) |
| Die Gap | 0.030 | inches |
| Air Ring Temperature | 10° | C. (50° F.) |

As seen from Tables 1 and 2, the films produced from aliphatic-aromatic copolyesters containing 100 mol % 1,4-butanediol, <45 mol % terephthalic acid, and >55 mol % adipic acid all demonstrated excellent microbial attachment and film fragmentation. Films produced from copolyesters containing 100 mol % 1,4-butanediol, >45 mol % terephthalic acid, and <55 mol % adipic acid showed minimal attachment and fragmentation. Commercially available bags produced from aliphatic-aromatic copolyesters containing 100 mol % 1,4-butanediol, 46-7 mol % terephthalic acid, and 53-4 mol % adipic acid with the addition of high levels (30 wt %) of thermoplastic starch showed no attachment or fragmentation.

### Example 2

### Radiochemistry Analysis

Film Forming Procedure

Three carbon-14 labeled aliphatic-aromatic polyester resins (labeled on aromatic ring carbon) were synthesized using carbon-14 labeled terephthalic acid. The ingredients and method used to make the films are described below.

REACTOR CHARGE (50 ml round bottom 24/40STG)

| | | | |
|---|---|---|---|
| 1. | 3.92 | g | Dimethyl Terephthalate (DMT) for 42 mole % T; |
| | 4.01 | g | DMT for 43 mole % T; or |
| | 4.32 | g | DMT for 46 mole % T |
| 2. | 4.3136 | g | Adipic Acid |
| 3. | 8.0698 | g | 1,4-Butanediol |
| 4. | 0.10 | ml | Ti Catalyst 1.02 w/vol % in BuOH |
| 5. | 0.004 | g | C-14 labeled DMT (Lot#NEN2922-135) |
| | | | for 42 mole % T; |
| | 0.005 | g | C-14 labeled DMT (Lot#NEN2922-135) |
| | | | for 43 mole % T; |
| | | | or |
| | 0.005 | g | C-14 labeled DMT (Lot#NEN2922-135) |
| | | | for 46 mole % T |
| 6. | 6.1 | mg | Ultranox 626 slurried in 0.5 ml Butanediol |
| | | | added prior to increasing temp |
| | | | to 255° C. |

Procedure

1. Charged flask with items 1, 2, 3, 4, and 5; flushed with N₂ and evacuated with vacuum pump; flush 2×.

2. Heated flask at the following temperatures and times:

| Temp. ° C. | Time |
|---|---|
| 190 | 1 hr. |
| 200 | 1 hr. |
| 210 | 1.5 hr. |

Add ULTRANOX 626 (item 6)

| | |
|---|---|
| Up to 255 | 30 min. slight vac., vigorous boiling |
| Vac. increased to 0.11 Torr | |
| High Temp., High Vac. | 1.5 hr. |

The polymer had a light amber color and had increased in viscosity to the point that it was wrapping the stirrer and pulling away from the walls of the flask. The top of the polymer mass had the typical swirls or ripples because of the high viscosity.

3. Vacuum replaced with nitrogen, metal bath lowered, reaction flask cooled by room air and then cooled with water (30 min.).

4. After the polymer has hardened, the flask was immersed in the hot metal bath and “pulled” (2 min.).

5. The stirrer was allowed to rotate until the polymer was completely cooled (30 min.).

6. The flask was scored with a glass knife around the circumference perpendicular to the neck, cracked with a hot glass bead, and the halves were separated releasing the stirrer with the attached polymer.

The three resins obtained contain approximately 42 mole % terephthalic acid (T), 43 mole % T, and 46 mole % T. The mole % T was determined using proton NMR (duplicate analyses). The resin samples were stored in desiccant under nitrogen, at 0-2° C. until dissolved in a 1:3 methanol:methylene chlorine solvent mixture. The samples were solvent cast onto Teflon lined pans and cut into 1×2 inch strips. Thickness was controlled by the amount of polyester to solvent poured on to the pans. Six films were cut to keep final thickness to 1.0 mil±0.2 mil. Each film respresented 0.4 million disintegrations per minute (dpm)±1500 dpm.

Radiochemistry Testing Procedure

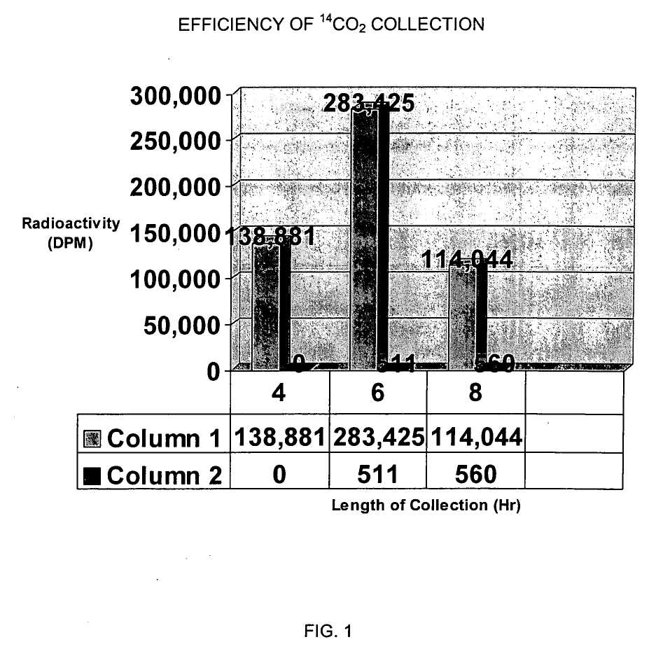

Using a modified procedure of ASTM D6340-98 Standard Method Recipe, 500 grams of compost was prepared and added to 2 L reaction kettles. Air flow was restricted to cause this compost to become microaerophilic over two weeks at ambient temperatures. The films were added to this microaerophilic compost minimizing air intake and mixed well with the compost. Once mixed, the vessel was sealed and the mixer was not used again in the experiment. Air bubbled through a water reservoir was added in 400 cc/min “flushes” to the bottom of the kettle for 24 periods of 90 seconds per week. Air flow was controlled by a tylan mass controller with Camile control. Off gas from the compost was bubbled through two sequential trap vessels of Carbosorb E for CO₂. A graph of the efficiency of this reagent is shown in FIG. 1.

The Carbosorb traps were tested weekly for the total dpm counts. Cumulative % of totals were calculated as follows: (current week total counts−previous week's counts)/(total counts in original film). Additional Carbosorb was added to the traps as needed. The material in the traps was kept in the liquid and active microbial state by the addition of 100 cc of septic tank effluent every 30 days.

The apparatus and method used were consistent with the D6340-98 ASTM method except for the following modifications:

1. Restriction of air flow as described above;

2. Addition of septic tank effluent as described above; and

3. Ambient indoor room temperatures were used instead of the 58° C. temperature used in this method, which was meant to simulate an active compost pile of greater than one ton.

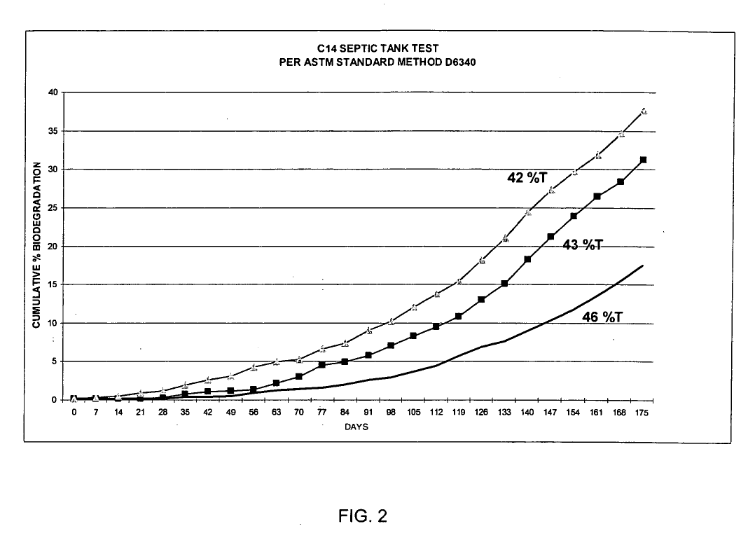

FIG. 2 shows the cumulative percentage of biodegradation (as calculated above) of the three films over a 180-day period. As seen from FIG. 2, all three films biodegraded greater than 5% at 120 days and greater than 10% at 150 days. The film containing 42 mole % T degraded at a faster rate and to a greater degree than the film containing 46 mole % T over the same time period.

1. An aliphatic-aromatic polyester which comprises aromatic monomers in an amount effective to render the polyester anaerobically biodegradable.

2. The aliphatic-aromatic polyester according to claim 1, wherein said aromatic monomers comprise terephthalic acid residues with up to 5 mole % of the terephthalic acid residues being replaced with aromatic dicarboxylic acid residues derived from the group consisting of isophthalic acid, 5-sulfoisophthalic acid, and 2,6-naphthalenedicarboxylic acid, based on the mole percentage of all diacid residues in the polyester equaling 100 mole %.

3. The aliphatic-aromatic polyester according to claim 2, which comprises from about 39 to about 43 mole percent of terephthalic acid residues, based on the mole percentage of all diacid residues in the polyester equaling 100 mole %.

4. The aliphatic-aromatic polyester according to claim 3, which comprises from about 40 to about 42 mole percent of terephthalic acid residues, based on the mole percentage of all diacid residues in the polyester equaling 100 mole %.

5. The aliphatic-aromatic polyester according to claim 1, which comprises diol residues comprising from about 85 to about 100 mole percent of 1,4-butanediol residues and from about 0 to about 15 mole percent of residues selected from the group consisting of ethylene glycol, diethylene glycol, and 1,3-propanediol, based on the mole percentage of all diol residues in the polyester equaling 100 mole %.

6. The aliphatic-aromatic polyester according to claim 1, which comprises up to about 15 mole % of hydroxycarboxylic acid residues, based on the mole percentage of all diacid residues in the polyester equaling 100 mole %.

7. The aliphatic-aromatic polyester according to claim 6, wherein said hydroxycarboxylic acid residues are derived from the group consisting of gamma-butyrolactone, caprolactone, lactic acid, 4-hydroxybutanoic acid, 4-hydroxyvaleric acid, 4-hydroxyhexanoic acid, 4-hydroxyoctanoic acid, polyhydroxybutyrate, polyhydroxybutyrate-co-valerate, polyhydroxybutyrate-co-octanoate, polyhydroxybutyrate-co-hexanoate, polycaprolactone, and polylactic acid.

8. An anaerobically biodegradable polyester comprising:
(a) diacid residues comprising from about 39 to about 43 mole percent of residues from an aromatic dicarboxylic acid and from about 57 to about 61 mole percent of residues from a non-aromatic dicarboxylic acid; and
(b) diol residues comprising from about 85 to about 100 mole percent of residues from 1,4-butanediol and from about 0 to about 15 mole percent of residues from another diol;
based on the mole percentage of all diacid residues in the polyester equaling 100 mole % and the mole percentage of all diol residues in the polyester equaling 100 mole %.

9. The anaerobically biodegradable polyester according to claim 8, wherein said aromatic dicarboxylic acid is selected from the group consisting of at least one off terephthalic acid, isophthalic acid, 5-sulfoisophthalic acid, and 2,6-naphthalenedicarboxylic acid.

10. The anaerobically biodegradable polyester according to claim 8, wherein said non-aromatic dicarboxylic acid is selected from the group consisting at least one of glutaric acid and adipic acid.

11. The anaerobically biodegradable polyester according to claim 8, wherein said another diol is selected from the group consisting of at least one of ethylene glycol, diethylene glycol, 1,3-propanediol, 1,5-pentanediol, 1,6-hexanediol, and 1,4-cyclohexanedimethanol.

12. The anaerobically biodegradable polyester according to claim 8, wherein the diacid residues comprise from about 40 to about 42 mole percent of residues from an aromatic dicarboxylic acid and from about 0.58 to about 60 mole percent of residues from a non-aromatic dicarboxylic acid.

13. The anaerobically biodegradable polyester according to claim 8, wherein said aromatic dicarboxylic acid is terephthalic acid and wherein up to 5 mole percent of the terephathalic acid is replaced with isophthalic acid, 5-sulfoisophthalic acid, or 2,6-naphthalenedicarboxylic acid.

14. The anaerobically biodegradable polyester according to claim 8, which further comprises up to about 15 mole % of hydroxycarboxylic acid residues, based on the total moles of diacid residues.

15. The aliphatic-aromatic polyester according to claim 14, wherein said hydroxycarboxylic acid residues are derived from the group consisting of gamma-butyrolactone, caprolactone, lactic acid, 4-hydroxybutanoic acid, 4-hydroxyvaleric acid, 4-hydroxyhexanoic acid, 4-hydroxyoctanoic acid, polyhydroxybutyrate, polyhydroxybutyrate-co-valerate, polyhydroxybutyrate-co-octanoate, polyhydroxybutyrate-co-hexanoate, polycaprolactone, and polylactic acid.

16. An anaerobically biodegradable polyester comprising:
(a) diacid residues comprising from about 39 to about 43 mole percent of residues from terephthalic acid and from about 57 to about 61 mole percent of residues from adipic acid; and
(b) diol residues comprising about 100 mole percent of residues from 1,4-butanediol;
based on the mole percentage of all diacid residues in the polyester equaling 100 mole % and the mole percentage of all diol residues in the polyester equaling 100 mole %.

17. The anaerobically biodegradable polyester according to claim 16, wherein the diacid residues comprise from about 40 to about 42 mole percent of residues from terephthalic acid and from about 58 to about 60 mole percent of residues from adipic acid.

18. An anaerobically biodegradable polyester comprising:
(a) diacid residues comprising from about 39 to about 43 mole percent of residues from terephthalic acid and from about 57 to about 61 mole percent of residues from glutaric acid; and
(b) diol residues comprising about 100 mole percent of residues from 1,4-butanediol;
based on the mole percentage of all diacid residues in the polyester equaling 100 mole % and the mole percentage of all diol residues in the polyester equaling 100 mole %.

19. The anaerobically biodegradable polyester according to claim 18, wherein the diacid residues comprise from about 40 to about 42 mole percent of residues from terephthalic acid and from about 58 to about 60 mole percent of residues from glutaric acid.

20. An anaerobically biodegradable composition comprising:
(I) a polyester comprising
(a) diacid residues comprising from about 39 to about 46 mole percent of residues from an aromatic dicarboxylic acid and from about 54 to about 61 mole percent of residues from a non-aromatic dicarboxylic acid, and
(b) diol residues comprising from about 85 to about 100 mole percent of residues from 1,4-butanediol and from about 0 to about 15 mole percent of residues from another diol;
based on the mole percentage of all diacid residues in the polyester equaling 100 mole % and the mole percentage of all diol residues in the polyester equaling 100 mole %; and
(II) a thermoplastic starch.

21. The anaerobically biodegradable composition according to claim 20, wherein said aromatic dicarboxylic acid is selected from the group consisting of terephthalic acid, isophthalic acid, 5-sulfoisophthalic acid, and 2,6-naphthalenedicarboxylic acid.

22. The anaerobically biodegradable composition according to claim 20, wherein said non-aromatic dicarboxylic acid is selected from the group consisting of glutaric and adipic.

23. The anaerobically biodegradable composition according to claim 20, wherein said another diol is selected from the group consisting of ethylene glycol, diethylene glycol, 1,3-propanediol, 1,5-pentanediol, 1,6-hexanediol, and 1,4-cyclohexanedimethanol.

24. The anaerobically biodegradable composition according to claim 20, wherein the diacid residues comprise from about 41 to about 43 mole percent of an aromatic dicarboxylic acid and from about 57 to about 59 mole percent of a non-aromatic dicarboxylic acid.

25. The anaerobically biodegradable polyester according to claim 20, wherein said aromatic dicarboxylic acid is terephthalic acid and wherein up to 5 mole percent of the terephathalic acid is replaced with isophthalic acid, 5-sulfoisophthalic acid, or 2,6-naphthalenedicarboxylic acid.

26. The anaerobically biodegradable composition according to claim 20, which comprises from about 5 to about 70 weight percent of the thermoplastic starch.

27. The anaerobically biodegradable composition according to claim 20, which further comprises from about 0.1 to about 60 weight percent of an inorganic salt comprising a metal ion selected from the group consisting of calcium, magnesium, sodium, potassium, titanium, silicon, and aluminum.

28. The anaerobically biodegradable composition according to claim 27, wherein the inorganic salt is selected from the group consisting of talc, calcium carbonate, magnesium carbonate, potassium carbonate, sodium carbonate, calcium chloride, magnesium chloride, calcium phosphate, titanium oxide, silicone oxide, aluminum oxide, and mixtures thereof.

29. The anaerobically biodegradable composition according to claim 20, which further comprises a processing aid, filler, surfactant, plasticizer, compatibilizer, impact modifier, nucleating agent, anti-oxidant, heat or ultraviolet stabilizer, colorant, anti-static agent, lubricant, blowing agent, dispersant, thickening agent, antimicrobial agent, or mixtures thereof.

30. The anaerobically biodegradable composition according to claim 20, wherein the polyester further comprises up to about 15 mole % of hydroxycarboxylic acid residues, based on the total moles of diacid residues.

31. The aliphatic-aromatic composition according to claim 30, wherein said hydroxycarboxylic acid residues are derived from the group consisting of gamma-butyrolactone, caprolactone, lactic acid, 4-hydroxybutanoic acid, 4-hydroxyvaleric acid, 4-hydroxyhexanoic acid, 4-hydroxyoctanoic acid, polyhydroxybutyrate, polyhydroxybutyrate-co-valerate, polyhydroxybutyrate-co-octanoate, polyhydroxybutyrate-co-hexanoate, polycaprolactone, and polylactic acid.

32. An anaerobically biodegradable composition comprising:
(I) a polyester comprising
(a) diacid residues comprising from about 39 to about 43 mole percent of residues from an aromatic dicarboxylic acid and from about 57 to about 61 mole percent of residues from a non-aromatic dicarboxylic acid, and
(b) diol residues comprising from about 85 to about 100 mole percent of residues from 1,4-butanediol and from about 0 to about 85 mole percent of residues from another diol;
based on the mole percentage of all diacid residues in the polyester equaling 100 mole % and the mole percentage of all diol residues in the polyester equaling 100 mole %; and
(II) an inorganic salt.

33. The anaerobically biodegradable composition according to claim 32, wherein said aromatic dicarboxylic acid is selected from the group consisting of terephthalic acid, isophthalic acid, 5-sulfoisophthalic acid, and 2,6-naphthalenedicarboxylic acid.

34. The anaerobically biodegradable composition according to claim 32, wherein said non-aromatic dicarboxylic acid is selected from the group consisting of glutaric acid and adipic acid.

35. The anaerobically biodegradable composition according to claim 32, wherein said another diol is selected from the group consisting of ethylene glycol, diethylene glycol, 1,3-propanediol, 1,5-pentanediol, 1,6-hexanediol, and 1,4-cyclohexanedimethanol.

36. The anaerobically biodegradable composition according to claim 32, wherein the diacid residues comprise from about 40 to about 42 mole percent of an aromatic dicarboxylic acid and from about 58 to about 60 mole percent of a non-aromatic dicarboxylic acid.

37. The anaerobically biodegradable polyester according to claim 32, wherein said aromatic dicarboxylic acid is terephthalic acid and wherein up to 5 mole percent of the terephathalic acid is replaced with isophthalic acid, 5-sulfoisophthalic acid, or 2,6-naphthalenedicarboxylic acid.

38. The anaerobically biodegradable composition according to claim 32, wherein the inorganic salt is selected from the group consisting of talc, calcium carbonate, magnesium carbonate, potassium carbonate, sodium carbonate, calcium chloride, magnesium chloride, calcium phosphate, titanium oxide, silicone oxide, aluminum oxide, and mixtures thereof.

39. The anaerobically biodegradable composition according to claim 32, which further comprises a processing aid, filler, surfactant, plasticizer, compatibilizer, impact modifier, nucleating agent, anti-oxidant, heat or ultraviolet stabilizer, colorant, anti-static agent, lubricant, blowing agent, dispersant, thickening agent, antimicrobial agent, or mixtures thereof.

40. The anaerobically biodegradable composition according to claim 32, wherein the polyester further comprises up to about 15 mole % of hydroxycarboxylic acid residues, based on the total moles of diacid residues.

41. The aliphatic-aromatic composition according to claim 40, wherein said hydroxycarboxylic acid residues are derived from the group consisting of gamma-butyrolactone, caprolactone, lactic acid, 4-hydroxybutanoic acid, 4-hydroxyvaleric acid, 4-hydroxyhexanoic acid, 4-hydroxyoctanoic acid, polyhydroxybutyrate, polyhydroxybutyrate-co-valerate, polyhydroxybutyrate-co-octanoate, polyhydroxybutyrate-co-hexanoate, polycaprolactone, and polylactic acid.

42. An article of manufacture which comprises the anaerobically biodegradable polyester according to claim 8.

43. The article of manufacture according to claim 42, which is a film, fiber, non-woven fabric, or adhesive.

44. An absorbent article comprising a topsheet, a backsheet, and an absorbent layer disposed between the topsheet and the backsheet, wherein at least a portion of the topsheet or the backsheet comprises the anaerobically biodegradable polyester according to claim 8.

45. A tampon applicator assembly comprising a barrel and a plunger, wherein at least a portion of the barrel or the plunger comprises the anaerobically biodegradable polyester according to claim 8.
